(19) United States
(12) Patent Application Publication
(10) Pub. No.: US 2013/0141613 A1
(43) Pub. Date: Jun. 6, 2013

(54) DIGITAL IMAGE PROCESSING APPARATUS AND DIGITAL PHOTOGRAPHING APPARATUS INCLUDING THE SAME

(71) Applicant: SAMSUNG ELECTRONICS CO., LTD., Suwon-si (KR)

(72) Inventors: Tae-hoon Kang, Seoul (KR); Jong-sun Kim, Suwon-si (KR); Won-seok Song, Seoul (KR); Myung-kyu Choi, Suwon-si (KR); Kwang-il Hwang, Suwon-si (KR)

(73) Assignee: SAMSUNG ELECTRONICS CO., LTD., Suwon-si (KR)

(21) Appl. No.: 13/685,895

(22) Filed: Nov. 27, 2012

(30) Foreign Application Priority Data
Dec. 1, 2011 (KR) 10-2011-0127859

(51) Int. Cl. G06F 3/041; H04N 5/232; G06F 3/01

(52) U.S. Cl. CPC G06F 3/041; G06F 3/011; H04N 5/23216
USPC 348/231.99; 345/156

(57) ABSTRACT

A digital image processing apparatus includes a storage unit that stores an image, a display unit that displays a stored image, a sensor that senses a motion of a user and generates a sensing signal, and a control unit that controls display of relevant information about an image displayed according to the sensing signal.

### CROSS-REFERENCE TO RELATED PATENT APPLICATIONS

This application claims the benefit of Korean Patent Application No. 10-2011-0127859, filed on Dec. 1, 2011, in the Korean Intellectual Property Office, the disclosure of which is incorporated herein in its entirety by reference.

### BACKGROUND

1. Field of the Invention

Embodiments relate to a digital image processing apparatus and a digital photographing apparatus including the same.

2. Description of the Related Art

Digital photographing apparatuses such as digital cameras or camcorders have been widely distributed with the development of technology such as improved battery performance and compact size thereof. A digital photographing apparatus requires a digital image processing apparatus equipped with various functions so that a user may photograph a better quality image.

### SUMMARY

Embodiments provide an intuitive method which can enable a user to identify information related to an image reproduced in a digital image processing apparatus and a digital photographing apparatus.

According to an aspect, a digital image processing apparatus includes a storage unit that stores an image, a display unit that displays a stored image, a sensor that senses a motion of a user and generates a sensing signal, and a control unit that controls display of relevant information about an image displayed according to the sensing signal.

The display unit may include a main display unit that displays a reproduction image, and an auxiliary display unit that displays the relevant information.

The main display unit and the auxiliary display unit may be arranged to face opposite directions.

When the digital image processing apparatus is rotated such that directions that the main display unit and the auxiliary display unit face are switched, the control unit may control the relevant information to be displayed on the auxiliary display unit.

The sensor may be a gyro sensor that senses a motion of the digital image processing apparatus.

A type of the relevant information displayed on the auxiliary display unit may vary according to a rotation direction of the digital image processing apparatus.

A characteristic of the sensing signal may vary according to a rotation direction of the digital image processing apparatus.

The display unit may include a touch panel and the sensor may be a touch sensor that senses contact with the user.

When a part of the user contacts the sensor and another part of the user contacts and drags on the touch panel, the control unit may control the displayed image to be switched to the relevant information about the displayed image and may display the relevant information on the display unit.

The touch sensor may be arranged at at least one side edge of the display unit.

A type of the relevant information to be displayed may vary according to a position of the touch sensor contacted by the user.

When the displayed image is switched to the relevant information, the control unit may generate a graphic effect same as an act of flipping an actual picture.

The relevant information may be EXIF data.

The relevant information may be a memo recorded in relation to the reproduction image.

According to another aspect, a digital photographing apparatus includes a photographing unit that photographs an image of an object in a photography mode, a storage unit that stores the image photographed by the photographing unit, a display unit that displays a stored image in a reproduction mode, a sensor that senses a user's motion and generates a sensing signal, and a control unit that controls display of relevant information about an image displayed according to the sensing signal.

The display unit may include a main display unit that displays a reproduction image, and an auxiliary display unit that displays the relevant information and may be arranged in an opposite direction to the main display unit.

When the digital photographing apparatus is rotated such that directions that the main display unit and the auxiliary display unit face are switched, the control unit may control the relevant information to be displayed on the auxiliary display unit.

The display unit may include a touch panel and the sensor may be a touch sensor that is arranged at at least one side edge of the display unit and senses contact of a user's body.

When a part of the user's body contacts the sensor and another part of the user's body contacts and drags on the touch panel, the control unit may control the displayed image to be switched to the relevant information about the displayed image and displayed on the display unit.

When the displayed image is switched to the relevant information, the control unit may generate a graphic effect same as an act of flipping an actual picture.

### BRIEF DESCRIPTION OF THE DRAWINGS

The above and other features and advantages will become more apparent by describing in detail exemplary embodiments with reference to the attached drawings in which:

FIG. 1 is a block diagram schematically illustrating a digital photographing apparatus according to an embodiment;

FIGS. 2A and 2B are view schematically illustrating the appearance of the digital photographing apparatus of FIG. 1;

FIG. 3 is a view schematically illustrating a method of processing an image in the digital photographing apparatus of FIG. 1, according to an embodiment;

FIG. 4 is a view schematically illustrating a method of processing an image in the digital photographing apparatus of FIG. 1, according to another embodiment;

FIG. 5 is a block diagram schematically illustrating a digital photographing apparatus according to another embodiment;

FIG. 6 is a view schematically illustrating the appearance of the digital photographing apparatus of FIG. 5;

FIG. 7 is a view schematically illustrating a method of processing an image in the digital photographing apparatus of FIG. 5, according to an embodiment;

FIG. 8 is a view schematically illustrating a method of processing an image in the digital photographing apparatus of FIG. 5, according to another embodiment; and

FIGS. 9 through 11 are flowcharts for explaining a method of processing an image according to an embodiment.

### DETAILED DESCRIPTION

The attached drawings for illustrating exemplary embodiments are referred to in order to gain a sufficient understanding of the invention, the merits thereof, and the objectives accomplished by the implementation of the invention. Hereinafter, exemplary embodiments will be described in detail with reference to the attached drawings. Like reference numerals in the drawings denote like elements.

The terms used in the present specification are used for explaining a specific exemplary embodiment, not limiting the present inventive concept. Thus, the expression of singularity in the present specification includes the expression of plurality unless clearly specified otherwise in context. Also, the terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

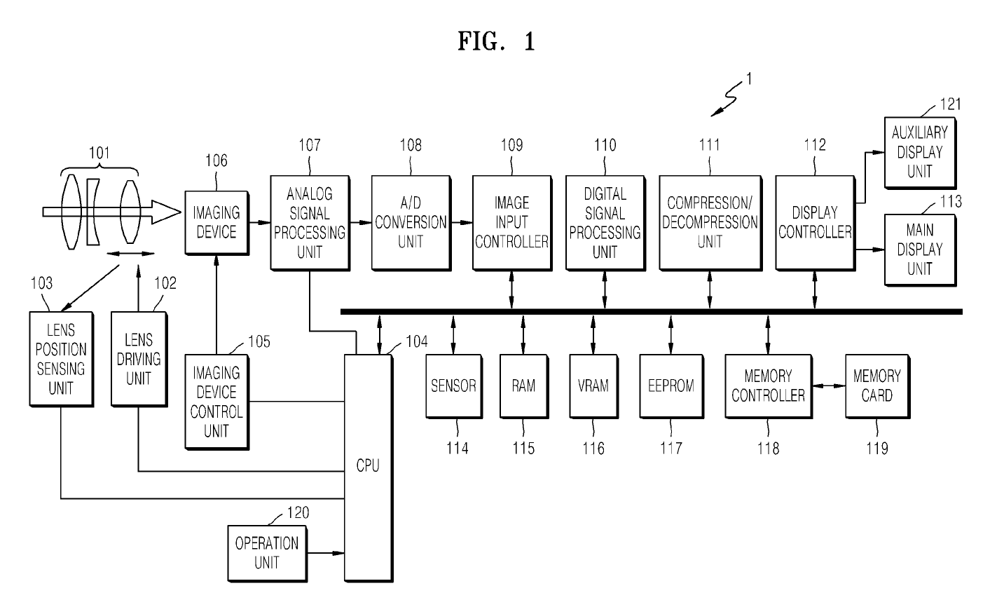

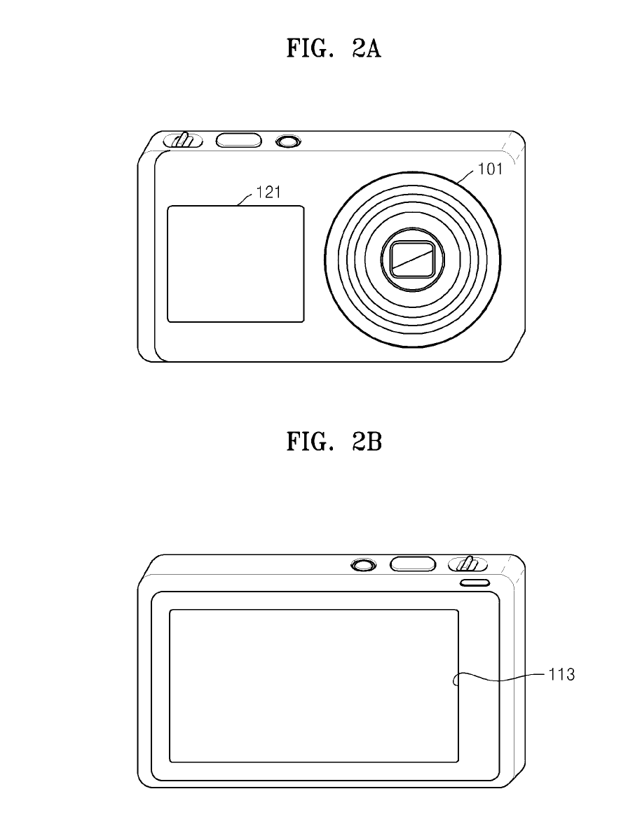

FIG. 1 is a block diagram schematically illustrating a digital photographing apparatus 1 according to an embodiment. FIGS. 2A and 2B are view schematically illustrating the appearance of the digital photographing apparatus 1 of FIG. 1.

Referring to FIGS. 1 through 2B, the digital photographing apparatus 1 can include a lens 101, a lens driving unit 102, a lens position sensing unit 103, a CPU 104, an imaging device control unit 105, an imaging device 106, an analog signal processing unit 107, an ND conversion unit 108, an image input controller 109, a digital signal processing unit 110, a compression/decompression unit 111, a display controller 112, a main display unit 113, a sensor 114, a RAM 115, a VRAM 116, an EEPROM 117, a memory controller 118, a memory card 119, an operation unit 120, and an auxiliary display unit 121.

The lens 101 can include a focus lens and a zoom lens. The lens 101 may perform a zoom ratio control function by driving of the zoom lens and a focus control function by driving of the focus lens.

The lens driving unit 102 can drive the zoom lens and the focus lens under the control of the CPU 104. The lens driving unit 102 may include a plurality of motors for driving each of the zoom lens and the focus lens.

The lens position sensing unit 103 can sense positions of the zoom lens and the focus lens and can transmit information about the positions to the CPU 104.

The CPU 104 can control an overall operation of the digital photographing apparatus 1. The CPU 104 may receive an operation signal from the operation unit 120 and can transmit a command corresponding to the operation signal to each part.

The imaging device control unit 105 can generate a timing signal and can apply the timing signal to the imaging device 106, thereby controlling an imaging operation of the imaging device 106. When accumulation of electric charges at each scanning line is completed, the imaging device control unit 105 can control sequential reading-out of image signals.

The imaging device 106 can capture image light of an object passing through the lens 101 to generate an image signal. The imaging device 106 may include a plurality of photoelectric transformation devices arranged in a matrix form and an electric charge transmission path through which electric charges are moved from the photoelectric transformation devices.

The analog signal processing unit 107 can remove noise from the image signal read out from the imaging device 106 or can amplify the amplitude of a signal to a certain level. The A/D conversion unit 108 can convert an analog image signal output from the analog signal processing unit 107 to a digital image signal.

The image input controller 109 can control image processing in each subsequent part with respect to the image signal output from the A/D conversion unit 108. The image signal output from the image input controller 109 may be temporarily stored in the RAM 115.

The CPU 104 or the digital signal processing unit 110 may perform an auto focus (AF) process, an auto white balance (AWB) process, an auto exposure (AE) process, etc. by using the image signal output from the image input controller 109. However, embodiments are not limited thereto and a separate structure for performing the AF process, the AWB process, the AE process, etc. may be provided.

The digital signal processing unit 110 can perform a series of image signal processes such as gamma correction with respect to the image signal output from the image input controller 109 and can generate a live view image or a capture image that may be displayed on the main display unit 113 or the auxiliary display unit 121.

The compression/decompression unit 111 can perform compression and decompression of an image signal on which image signal processing is performed. For compression, an image signal can be compressed in a format of, for example, JPEG compression format, an H.264 compression format, etc. An image file including image data generated by the compression process and EXIF data generated during photographing of a corresponding image can be generated. A generated image file can be transmitted to the memory controller 118. The memory controller 118 can transmit the image file to the memory card 119 and can store the image file therein. When a text memo or a voice memo is added to the image photographed by a user, the added memory may be included in the image file.

In one or more embodiments, a “photographing unit” can be a concept including all of the lens 101, the lens driving unit 102, the lens position sensing unit 103, the CPU 104, the imaging device control unit 105, the imaging device 106, the analog signal processing unit 107, the A/D conversion unit 108, the image input controller 109, the digital signal processing unit 110, the compression/decompression unit 111, etc and can signify a structure for photographing an image and generating an image file. The photographing unit is not limited to any one of the above structures.

The display controller 112 can control image output to the main display unit 113 and the auxiliary display unit 121. The main display unit 113 and the auxiliary display unit 121 can display images such as photographed images or live view images, or various setting information. The image or information to be displayed by the main display unit 113 and the auxiliary display unit 121 may be previously set or set by a user. The main display unit 113 and the auxiliary display unit 121 may be liquid crystal displays (LCDs) or OLEDs. The display controller 112 may be a driver corresponding thereto.

The main display unit 113 and the auxiliary display unit 121 may be installed in the digital photographing apparatus 1 to face opposite directions. For example, the main display unit 113 may be installed to face the opposite direction to a direction that the lens 101 and the imaging device 106 face so that a user may check a live view image during a general photographing operation. The auxiliary display unit 121 may be installed to face the same direction as a direction that the lens 101 and the imaging device 106 face so that a user may check an image during self photography.

The sensor 114 can sense a user's motion and can generate a sensing signal. That is, the sensor 114 can sense a motion of the digital photographing apparatus 1. The sensor 114 can transmit a generated sensing signal to the CPU 104. The characteristic of a sensing signal may vary according to the direction of rotating the digital photographing apparatus 1. Accordingly, the CPU 104 may recognize a type of a user's motion. The sensor 114 may be a gyro sensor.

The RAM 115 can store various data and signals. The VRAM 116 can temporarily store information such as an image to be displayed on the main display unit 113.

The EEPROM 117 may store an executable program for controlling the digital photographing apparatus 1 or various management information. Also, the EEPROM 117 may store an illumination correction curve according to an average illumination of an image that is described below.

As described above, the memory card 119 can store an image file under the control of the memory controller 118. That is, the memory card 119 may be an example of a storage unit. However, a storage unit is not limited to the memory card 119 and any structure capable of storing an image may be used therefor.

The operation unit 120 can be a part to input various commands from a user to operate the digital photographing apparatus 1. The operation unit 120 may include a shutter release button, a main switch, a mode dial, a menu button, etc.

Although the lens 101 and a main body are integrally formed in the embodiment illustrated in FIG. 1, embodiments are not limited thereto. For example, the digital photographing apparatus 1 may be configured such that a lens module including the lens 101, the lens driving unit 102, and the lens position sensing unit 103 can be detachably installed on the main body.

When the lens module is detachably provided to the main body in the digital photographing apparatus 1, the lens module may be provided with a separate control unit. The control unit provided in the lens module may perform driving and position sensing of the lens 101 according to a command from the CPU 104 of the main body.

Also, although it is not illustrated in FIG. 1, the digital photographing apparatus 1 may further include a shutter, an aperture, etc. FIG. 1 illustrates only a structure needed for explaining the present embodiment and a variety of structures may be further added.

In this embodiment, in a reproduction mode where a photographed and stored image is reproduced, the CPU 104 can display on the main display unit 113 any one of the images stored in the memory card 119 as a reproduction image. The CPU 104 may control the display controller 112 to make information related to an image reproduced by the main display unit 113 to be displayed on the auxiliary display unit 121, according to the sensing signal received from the sensor 114. The information related to the reproduction image may be EXIF data included in an image file when the image file is generated, or a memo recorded in text or by voice.

A method of processing an image in the digital photographing apparatus 1 of FIG. 1 is described in detail below,

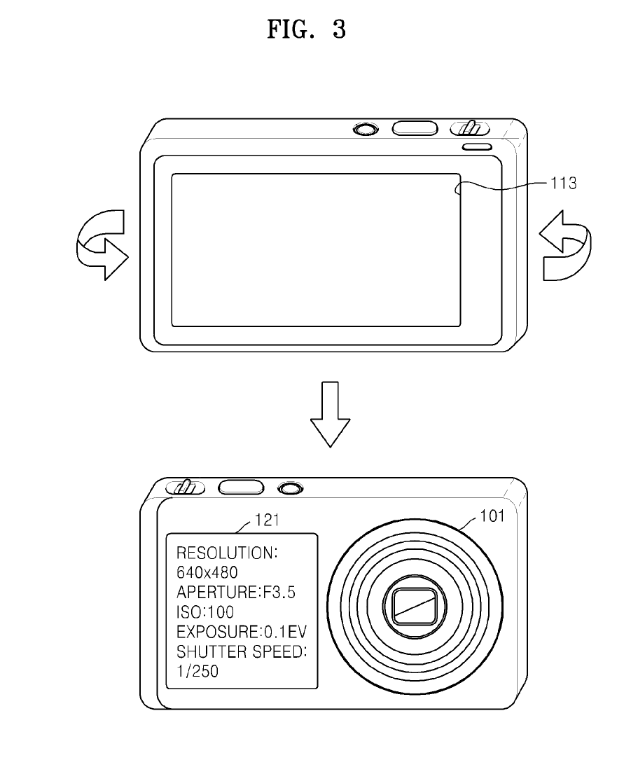

FIG. 3 is a view schematically illustrating a method of processing an image in the digital photographing apparatus 1 of FIG. 1, according to an embodiment. Referring to FIG. 3, when a reproduction mode is initiated by a user, any one of the images stored in the memory card 119 can be displayed on the main display unit 113 of the digital photographing apparatus 1 as a reproduction image. It is assumed that the main display unit 113 initially faces a user so that the user may check the reproduction image.

The user can rotate the digital photographing apparatus 1 so that the user may see a front surface of the digital photographing apparatus 1, that is, a surface where the auxiliary display unit 121 is installed. The rotation direction of the digital photographing apparatus 1 can be that the left side of the main display unit 113 comes up from the plane of the figure and the right side thereof goes down into the plane of the figure. That is, the digital photographing apparatus 1 can be rotated counterclockwise viewed from the top of the digital photographing apparatus 1.

When the digital photographing apparatus 1 is rotated by a user, the sensor 114 can sense that the directions which the main display unit 113 and the auxiliary display unit 121 face are switched. The sensor 114 can generate a sensing signal corresponding thereto.

The CPU 104 can receive the sensing signal and can recognize the rotation of the digital photographing apparatus 1. The CPU 104 can then analyze the sensing signal and can recognize a rotation direction. The CPU 124 can control the information related to the reproduction image to be displayed on the auxiliary display unit 121 according to the recognized rotation direction. In this embodiment, the digital photographing apparatus 1 can be rotated such that the left side of the main display unit 113 comes up and the right side thereof goes down, and the CPU 104 can recognize the rotation and can control EXIF data as the relevant information to be displayed on the auxiliary display unit 121. The EXIF data may include resolution of an image, an aperture value during photography, sensitivity, exposure, a shutter speed, etc. However, these items are exemplary and any item included in the EXIF data may be displayed on the auxiliary display unit 121. Also, a user may choose items to be displayed.

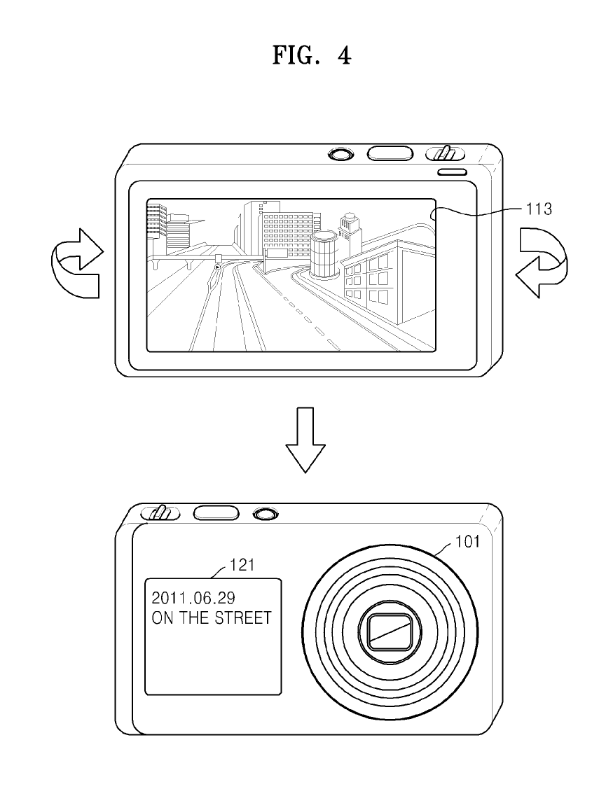

FIG. 4 is a view schematically illustrating a method of processing an image in the digital photographing apparatus 1 of FIG. 1, according to another embodiment. Referring to FIG. 4, in a state in which the reproduction image is displayed on the main display unit 113 as illustrated in FIG. 3, the digital photographing apparatus 1 can be rotated in a direction opposite to the direction illustrated in FIG. 3.

The sensor 114 can sense that the directions which the main display unit 113 and the auxiliary display unit 121 face are switched and can generate a sensing signal corresponding thereto. The characteristic of the sensing signal generated by the sensor 114 may be different from that of the sensing signal generated in FIG. 3.

The CPU 104 can receive the sensing signal having a characteristic different from that of the sensing signal generated in FIG. 3. The CPU 104 can recognize the rotation of the digital photographing apparatus 1 and the rotation direction thereof according to a received sensing signal. That is, the CPU 104 can recognize the rotation of the digital photographing apparatus 1 in the opposite direction to that of FIG. 3.

The CPU 104 can control a memo recorded by a user as the relevant information to be displayed on the auxiliary display unit 121. The memo recorded by the user may be a text recording a photography place or user's thoughts. However, the memory is not limited thereto and may be voice recording.

The motions of a user in FIGS. 3 and 4 can be similar to an action of flipping a developed actual picture to see a memo personally written down on a rear surface of the picture. That is, the digital photographing apparatus 1 can recognize that the user's motion is the same as an act of flipping an actual picture. As a result, relevant information can be displayed on the auxiliary display unit 121 as if one sees a memo written down on a rear surface of the picture.

As described above with reference to FIGS. 3 and 4, the sensing signal generated by the sensor 114 may vary according to the rotation direction of the digital photographing apparatus 1. The type of the relevant information displayed on the auxiliary display unit 121 may be made different. The user may choose the type of the relevant information to be displayed on the auxiliary display unit 121 according to the rotation direction of the digital photographing apparatus 1, and the chosen content may be modified.

Although, in FIGS. 3 and 4, a case of rotating the digital photographing apparatus 1 in the left/right direction is described, embodiments are not limited thereto. In a case of rotating in the up/down direction, the user may choose the type of the relevant information to be displayed on the auxiliary display unit 121.

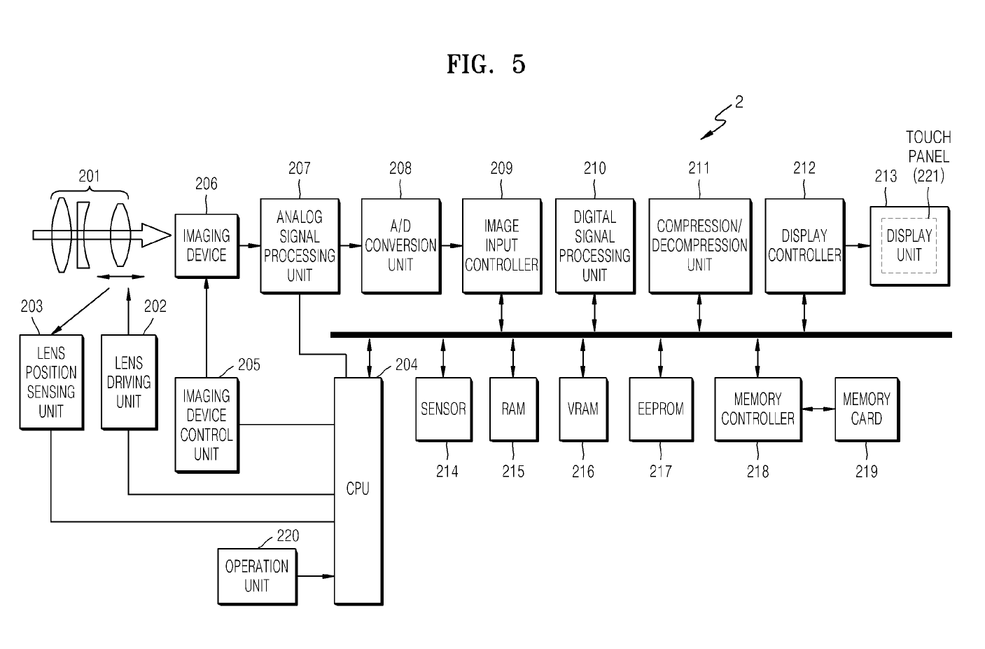

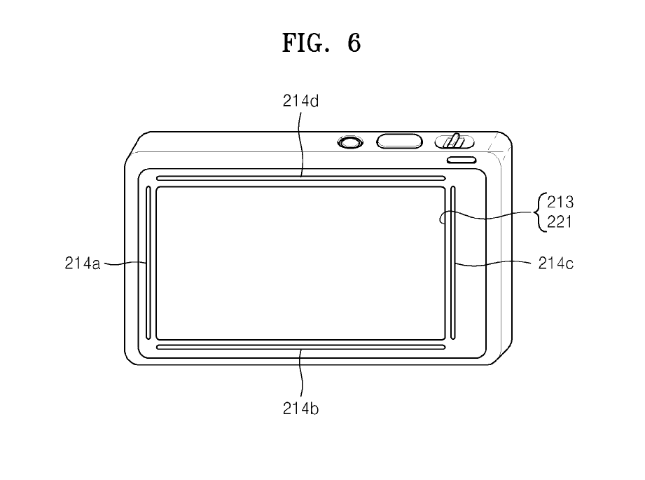

FIG. 5 is a block diagram schematically illustrating a digital photographing apparatus 2 according to another embodiment. FIG. 6 is a view schematically illustrating the appearance of the digital photographing apparatus 2 of FIG. 5. The following description mainly focuses on differences from the digital photographing apparatus 1 of FIGS. 1 through 2B and any redundant description will be omitted herein.

Referring to FIGS. 5 and 6, the digital photographing apparatus 2 according to the present embodiment can further comprise a touch panel 221 in a display unit 213. The touch panel 221 may sense contact of a part of a user's body and can generate a sensing signal according to a pattern of a touch motion of a user. The touch panel 221 may recognize not only a simple touch by a user but also a drag motion of moving in a touch state and can generate a sensing signal corresponding thereto.

Also, a sensor 214 according to the present embodiment may be a touch sensor for sensing touch of a user's body. The sensor 214 may be arranged at at least one side edge of the display unit 213. In this embodiment, the sensor 214 may be provided with a total of four (4) sensing bars 214a, 214b, 214c, and 214d respectively at the left, lower, right, and upper sides of the display unit 213 as illustrated in FIG. 6.

In this embodiment, in a reproduction mode in which a photographed and stored image is reproduced, the CPU 204 can display any one of the images stored in the memory card 219 as a reproduction image on the display unit 213. The CPU 204 can control a display controller 212 to change the reproduction image reproduced on the display unit 213 to relevant information about the reproduction image and display the relevant information on the display unit 213, according to a sensing signal received from the sensor 214 and the touch panel 221. The relevant information about the reproduction image may be EXIF data included in an image file when the image file is generated, or a memo recorded in text or by voice.

A method of processing an image in the digital photographing apparatus 2 of FIG. 5 is described in detail.

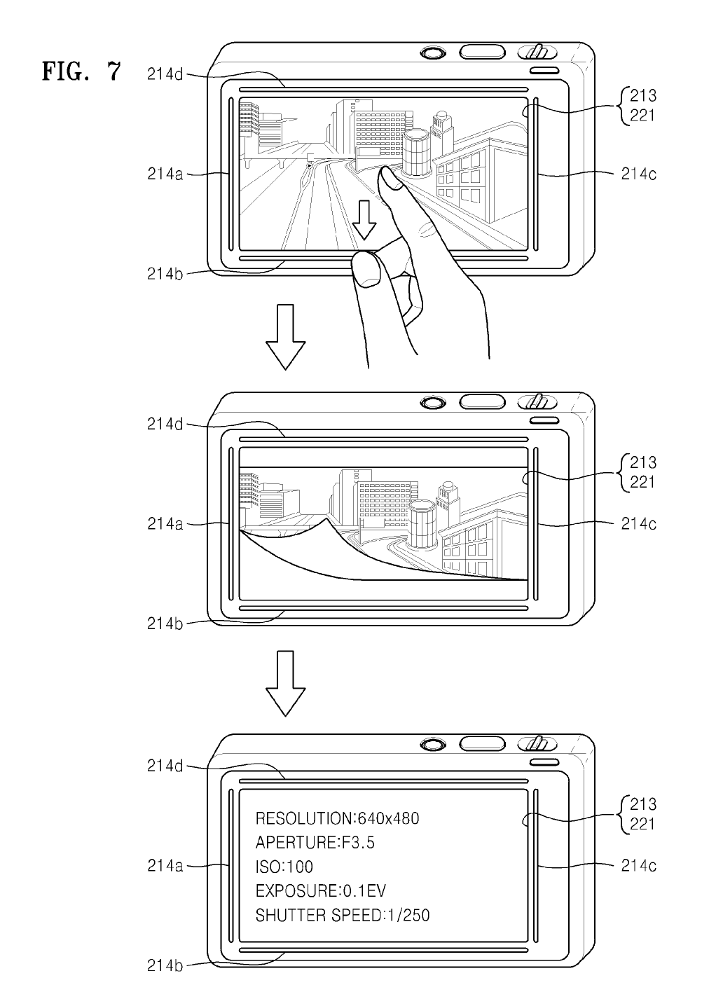

FIG. 7 is a view schematically illustrating a method of processing an image in the digital photographing apparatus 2 of FIG. 5, according to an embodiment. Referring to FIG. 7, when a reproduction mode is initiated by a user, any one of the images stored in the memory card 219 can be displayed on the display unit 213 of the digital photographing apparatus 2 as a reproduction image.

The user can touch the lower sensing bar 214b using a thumb and the touch panel 221 provided in the display unit 213 using an index finger. Then, the user can drag the index finger downwardly.

The sensor 214 can sense the user's touching of the lower sensing bar 214b and dragging on the touch panel 221. The sensor 214 can generate sensing signals corresponding thereto.

The CPU 204 can receive the sensing signals, can recognize that the user's motion is performed in the digital photographing apparatus 2, and can identify a type of the motion. Then, the CPU 204 can control the display unit 213 to switch the reproduction image to information related to the reproduction image according to the identified type. In this embodiment, the CPU 204 can recognize that the dragging on the touch panel 221 is performed in a state in which the lower sensing bar 214b at the lower side of the display unit 213 is in contact. Then, the CPU 204 can control EXIF data to be displayed on the display unit 213 as relevant information.

When switching the reproduction image to the relevant information, the CPU 204 may control the display controller 212 to generate the same graphic effect as an act of flipping an actual picture. In particular, in this embodiment in which a user touches the lower sensing bar 214b, the CPU 204 can switch the reproduction image to the relevant information by generating a graphic effect such as an act of flipping a picture from the bottom to the top as illustrated in the second image of FIG. 7.

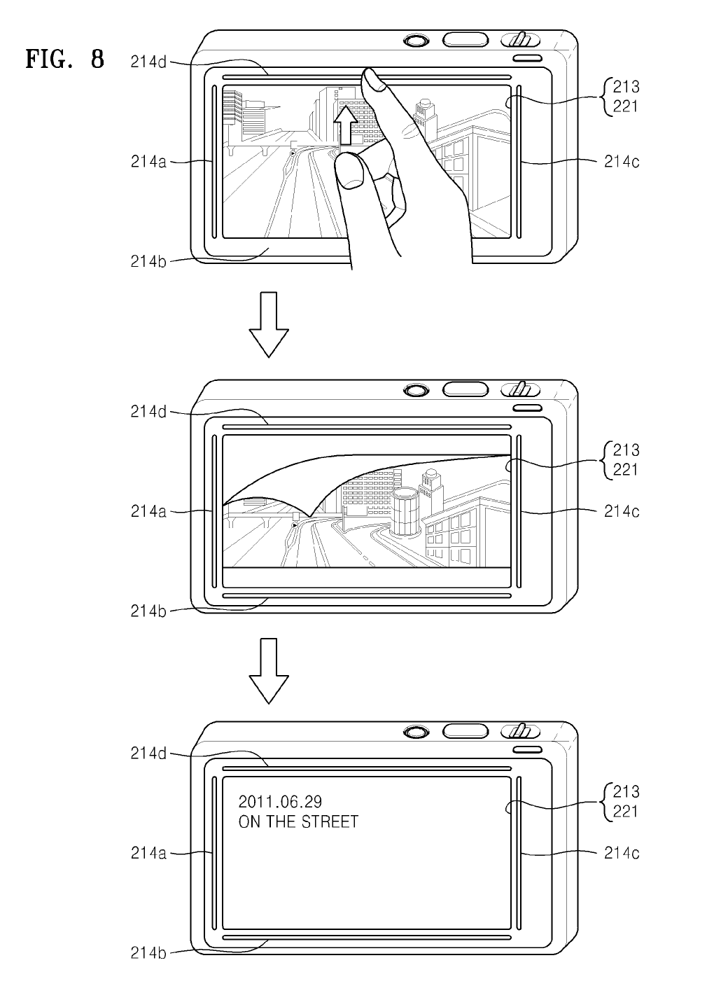

FIG. 8 is a view schematically illustrating a method of processing an image in the digital photographing apparatus 2 of FIG. 5, according to another embodiment. Referring to FIG. 8, when a reproduction mode is initiated by a user, any one of the images stored in the memory card 219 can be displayed on the display unit 213 of the digital photographing apparatus 2 as a reproduction image.

The user can touch the upper sensing bar 214d using an index finger and the touch panel 221 provided in the display unit 213 using a thumb. Then, the user can drag the thumb upwardly.

The sensor 214 can sense the user's touching of the upper sensing bar 214d and dragging on the touch panel 221. The sensor 214 can generate sensing signals corresponding thereto.

The CPU 204 can receive the sensing signals, can recognize that the user's motion is performed in the digital photographing apparatus 2, and can identify a type of the motion. Then, the CPU 204 can control the display unit 213 to switch the reproduction image to information related to the reproduction image according to the identified type. In this embodiment, the CPU 204 can recognize that the dragging on the touch panel 221 is performed in a state in which the upper sensing bar 214d at the upper side of the display unit 213 is in contact. Then, the CPU 204 can control a memo recorded by the user to be displayed on the display unit 213 as relevant information.

When switching the reproduction image to the relevant information, the CPU 204 may control the display controller 212 to generate the same graphic effect as an act of flipping an actual picture. In particular, in this embodiment in which a user touches the upper sensing bar 214d, the CPU 204 can switch the reproduction image to the relevant information by generating a graphic effect such as an act of flipping a picture from the top to the bottom as illustrated in the second image of FIG. 8.

The user's motions described in FIGS. 7 and 8 can be similar to a motion of seeing a memo that is personally recorded on a rear surface of an actually developed picture by flipping the picture. That is, the digital photographing apparatus 2 can recognize the user's motion that is the same as an act of flipping an actual picture. As a result, the reproduction image can be switched to the relevant information, and the relevant information can be displayed on the display unit 213 as if one sees a memo recorded on a rear surface of a picture.

As described above with reference to FIGS. 7 and 8, in the digital photographing apparatus 2, although a case of touching the upper sensing bar 214d or the lower sensing bar 214b is described, embodiments are not limited thereto. For example, in a case of touch and dragging the left sensing bar 214a or the right sensing bar 214c, the type of relevant information to be displayed on the display unit 213 may be chosen.

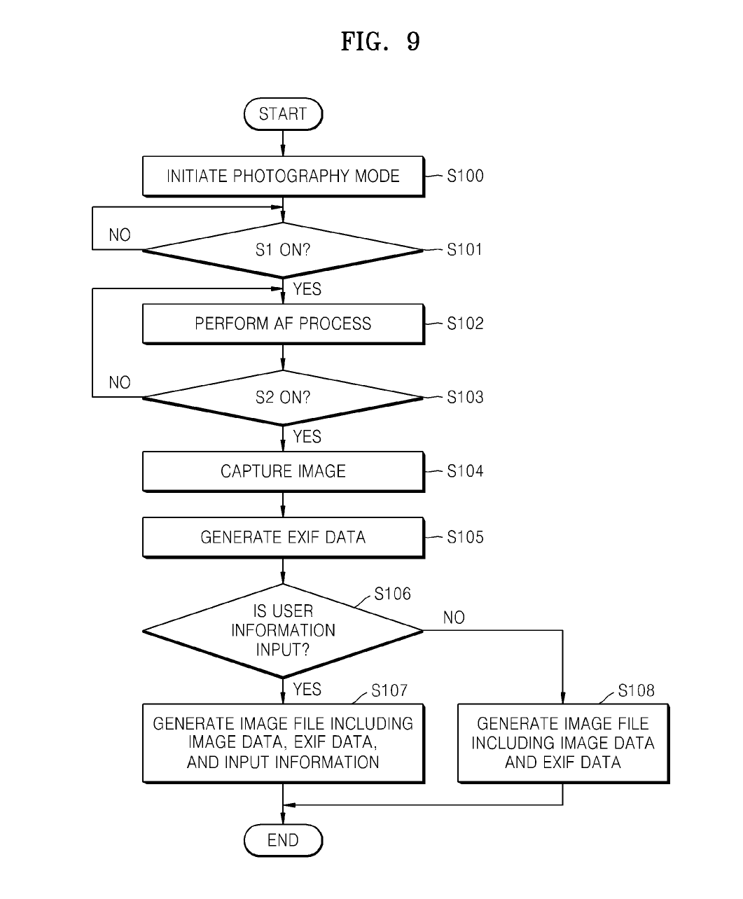

FIGS. 9 through 11 are flowcharts for explaining a method of processing an image according to an embodiment. Referring to FIG. 9, photographing and storing an image in a photography mode is explained. A photography mode can be initiated by a user's operation (S100). The imaging device 106 can generate an image signal by periodically capturing image light. The image signal can undergo various signal process and can be displayed real time.

While a live-view image is displayed as described above, it can be determined whether a half-shutter signal S1 is inputted by a user (S101). When the half-shutter signal S1 is inputted, an AF process can be performed (S102). It can be determined whether a shutter signal S2 is inputted (S103). When the shutter signal S2 is inputted, an image can be captured (S104).

When an image is captured, various photography conditions set for image capturing, for example, an image resolution, an aperture value, a sensitivity, an exposure value, a shutter speed, a photography time, orientation, etc., can be generated as EXIF data (S105). It can be determined whether there is information inputted by the user (S106). When there is information inputted by the user, such as a text memo or a voice memo, an image file including image data, EXIF data, and user input information can be generated and stored in a storage unit (S107).

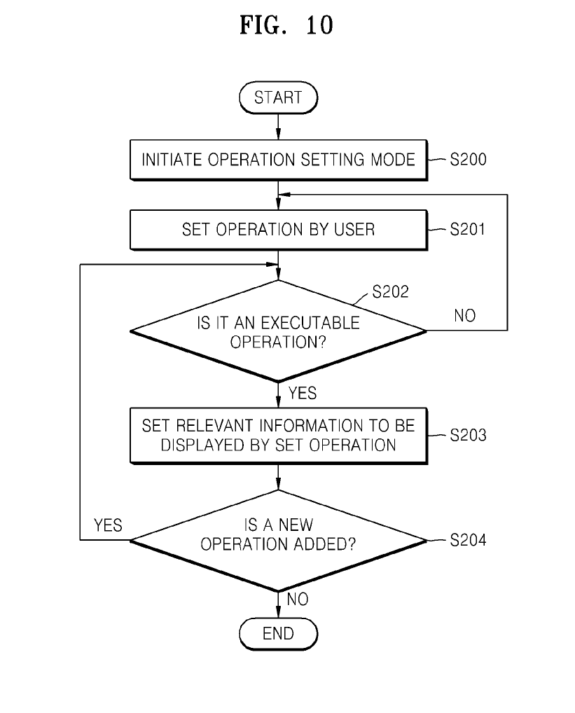

Referring to FIG. 10, user's presetting for adopting the present embodiment is described below. When an operation setting mode is initiated (S200), the user can set an operation to execute (S201).

The CPU 104 or 204 can determine whether the operation set by the user is executable (S202). If the operation is not executable, the process goes back to the operation S201 and a new operation can be set.

In contrast, if the operation set by the user is executable, relevant information to be displayed can be set by the operation set by the user (S203). For example, when the user sets the operation according to FIG. 3, relevant information to be displayed can be set corresponding to the set operation. That is, the EXIF data may be set to be displayed.

It can be determined whether the user added a new operation (S204). When there is an addition of a new operation, the process goes back to operation S202. Otherwise, the operation setting mode is terminated.

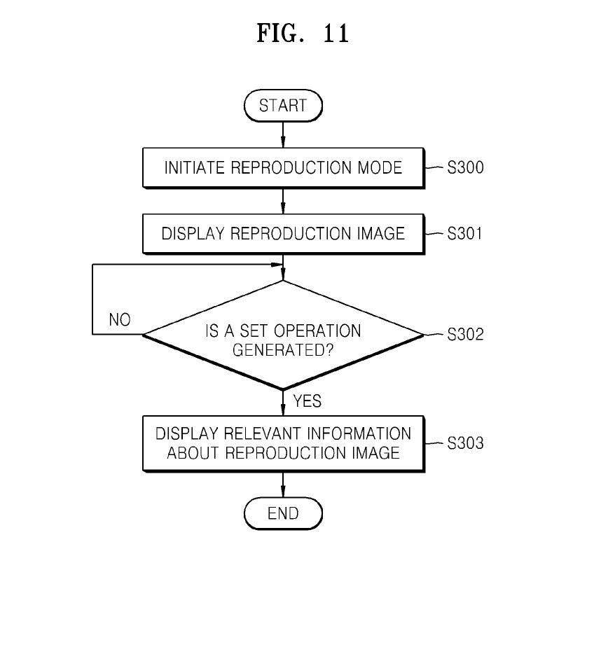

Referring to FIG. 11, when a reproduction mode is initiated (S300), any one of the images stored in the storage unit can be displayed as a reproduction image (S301). The image selected as a reproduction image may be the most recently captured image or an image corresponding to a condition previously set by the user.

While the reproduction image is displayed, it can be determined whether an operation set by the user is generated (S302). For example, it can be determined whether the operation to flip the digital photographing apparatus 1 or 2 as described in FIG. 3 or 4, or an operation of dragging as described in FIG. 7 or 8, is performed.

If it is determined that the set operation is generated, relevant information about the reproduction image can be displayed (S303). The relevant information being displayed may be one previously set by the user or may be different according to the type of the operation of the user that is generated.

As described above, the digital image processing apparatus according to various embodiments, and the digital photographing apparatuses 1 and 2 including the digital image processing apparatus, may provide an intuitive method for identifying information related to a reproduction image.

Conventionally, in order to check EXIF data or other relevant information related to a reproduction image, a user needed to operate buttons several times to perform a particular function. Thus, it is difficult for a user who is not familiar with the operation of an apparatus to identify relevant information.

However, in the digital photographing apparatuses 1 and 2 according to various embodiments, the relevant information of a reproduction image may be identified in a similar manner to an action of flipping an actually developed picture to see a personally recorded memo on a rear surface of the picture. That is, even a user who is not familiar with the operation of an apparatus may easily identify relevant information due to the intuitive method.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The particular implementations shown and described herein are illustrative examples of the invention and are not intended to otherwise limit the scope of the invention in any way.

The apparatus described herein may comprise a processor, a memory for storing program data to be executed by the processor, a permanent storage such as a disk drive, a communications port for handling communications with external devices, and user interface devices, including a display, keys, etc.

When software modules are involved, these software modules may be stored as program instructions or computer readable code executable by the processor on a non-transitory computer-readable media, random-access memory (RAM), read-only memory (ROM), CD-ROMs, DVDs, magnetic tapes, hard disks, floppy disks, and optical data storage devices. The computer readable recording media may also be distributed over network coupled computer systems so that the computer readable code is stored and executed in a distributed fashion. This media can be read by the computer, stored in the memory, and executed by the processor. Also, using the disclosure herein, programmers of ordinary skill in the art to which the invention pertains can easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The terminology used herein is for the purpose of describing the particular embodiments and is not intended to be limiting of exemplary embodiments of the invention. It will be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural. The words “mechanism” and “element” are used broadly and are not limited to mechanical or physical embodiments, but may include software routines in conjunction with processors, etc. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

Numerous modifications and adaptations will be readily apparent to those of ordinary skill in this art without departing from the spirit and scope of the invention. Therefore, the scope of the invention is defined not by the detailed description of the invention but by the following claims, and all differences within the scope will be construed as being included in the invention.

What is claimed is:

1. A digital image processing apparatus, comprising:
a storage unit that stores an image;
a display unit that displays a stored image;
a sensor that senses a motion of a user and generates a sensing signal; and
a control unit that controls display of relevant information about an image displayed according to the sensing signal.

2. The digital image processing apparatus of claim 1, wherein the display unit comprises:
a main display unit that displays a reproduction image; and
an auxiliary display unit that displays the relevant information.

3. The digital image processing apparatus of claim 2, wherein the main display unit and the auxiliary display unit are arranged to face opposite directions.

4. The digital image processing apparatus of claim 2, wherein, when the digital image processing apparatus is rotated such that directions that the main display unit and the auxiliary display unit face are switched, the control unit controls the relevant information to be displayed on the auxiliary display unit.

5. The digital image processing apparatus of claim 4, wherein the sensor is a gyro sensor that senses a motion of the digital image processing apparatus.

6. The digital image processing apparatus of claim 4, wherein a type of the relevant information displayed on the auxiliary display unit varies according to a rotation direction of the digital image processing apparatus.

7. The digital image processing apparatus of claim 4, wherein a characteristic of the sensing signal varies according to a rotation direction of the digital image processing apparatus.

8. The digital image processing apparatus of claim 1, wherein the display unit comprises a touch panel and the sensor is a touch sensor that senses contact with the user.

9. The digital image processing apparatus of claim 8, wherein, when a part of the user contacts the sensor and another part of the user contacts and drags on the touch panel, the control unit controls the displayed image to be switched to the relevant information about the displayed image and displays the relevant information on the display unit.

10. The digital image processing apparatus of claim 9, wherein the touch sensor is arranged at at least one side edge of the display unit.

11. The digital image processing apparatus of claim 10, wherein a type of the relevant information to be displayed varies according to a position of the touch sensor contacted by the user.

12. The digital image processing apparatus of claim 8, wherein, when the displayed image is switched to the relevant information, the control unit generates a graphic effect same as an act of flipping an actual picture.

13. The digital image processing apparatus of claim 1, wherein the relevant information is EXIF data.

14. The digital image processing apparatus of claim 1, wherein the relevant information is a memo recorded in relation to the reproduction image.

15. A digital photographing apparatus, comprising:
a photographing unit that photographs an image of an object in a photography mode;
a storage unit that stores the image photographed by the photographing unit;
a display unit that displays a stored image in a reproduction mode;
a sensor that senses a user's motion and generates a sensing signal; and
a control unit that controls display of relevant information about an image displayed according to the sensing signal.

16. The digital photographing apparatus of claim 15, wherein the display unit comprises:
a main display unit that displays a reproduction image; and
an auxiliary display unit that displays the relevant information and is arranged in an opposite direction to the main display unit.

17. The digital photographing apparatus of claim 16, wherein, when the digital photographing apparatus is rotated such that directions that the main display unit and the auxiliary display unit face are switched, the control unit controls the relevant information to be displayed on the auxiliary display unit.

18. The digital photographing apparatus of claim 15, wherein the display unit comprises a touch panel and the sensor is a touch sensor that is arranged at at least one side edge of the display unit and senses contact of a user's body.

19. The digital photographing apparatus of claim 18, wherein, when a part of the user's body contacts the sensor and another part of the user's body contacts and drags on the touch panel, the control unit controls the displayed image to be switched to the relevant information about the displayed image and displayed on the display unit.

20. The digital photographing apparatus of claim 19, wherein, when the displayed image is switched to the relevant information, the control unit generates a graphic effect same as an act of flipping an actual picture.
